(19) United States
(12) Patent Application Publication
(10) Pub. No.: US 2002/0052800 A1
(43) Pub. Date: May 2, 2002

(54) System, method and control program for e-commerce

(76) Inventor: Tomihiko Azuma, Tokyo (JP)

Correspondence Address: McGinn & Gibb, PLLC, Suite 200, 8321 Old Courthouse Road, Vienna, VA, 22182-3817, US

(21) Appl. No.: 09/984,228

(22) Filed: Oct. 29, 2001

(30) Foreign Application Priority Data
Oct. 30, 2000 (JP) 331435/2000

(51) Int. Cl. G06F 17/60

(52) U.S. Cl. 705/26

(57) ABSTRACT

A system, method and control program for e-commerce wherein it is possible to conduct business among a plurality of members who use a diversity of languages in security and at a lower cost are provided. An e-commerce market member terminal sends member registration application information to an e-commerce market control terminal. Accordingly, the e-commerce market control terminal sends a language information input request to the e-commerce market member terminal. Then, the e-commerce market member terminal sends the language information to the e-commerce market control terminal. After that, the e-commerce market control terminal stores the member registration application information and the language information in pairs. Besides, the e-commerce market control terminal controls a commodity dictionary wherein one commodity is written in a diversity of languages. On the basis of the commodity dictionary, the e-commerce market control terminal compiles a commodity dictionary corresponding to the specified language information, and sends the compiled dictionary to the e-commerce market member terminal. After that, the e-commerce market member terminal stores the compiled dictionary.

### BACKGROUND OF THE INVENTION

The present invention relates to an e-commerce system applied in an e-commerce market, and in particular, to a system, method and control program for e-commerce preferably applied when business transactions are performed among a plurality of members who uses a diversity of languages.

### DESCRIPTION OF THE RELATED ART

In an e-commerce market wherein a business transaction is performed through a communication line such as the Internet, merchandise information and so forth are exchanged applying an e-commerce system in which communication terminals owned by members participating in the transaction are connected to each other.

As shown in FIG. 1, this kind of conventional e-commerce system comprises e-commerce market member terminals 1, . . . , 1 (which consist of n pieces thereof) and an e-commerce market control terminal 2, which are connected through a communication line (for example, the Internet) NW. The e-commerce market member terminals 1, . . . , 1 are operated by each of the members conducting transactions, and receive merchandise information concerned with the transactions from the e-commerce market control terminal 2 through the Internet NW. The e-commerce market control terminal 2 receives merchandise information concerned with the transactions and so forth from the e-commerce market member terminals 1, . . . , 1 through the Internet NW, and centrally controls the received information.

In this e-commerce system, each of the members conducting transactions operates the e-commerce market member terminals 1, . . . , 1 to receive the merchandise information from the e-commerce market control terminal 2 through the Internet NW, and thereby, the transactions are performed between each of the members. The merchandise information is often displayed and exchanged only in English. When translation is required in conducting business, each of the members conducting the transactions translates the merchandise information individually.

However, in the conventional e-commerce system as described above, the following problems have occurred.

First, the merchandise information is often provided in English only as described above. Thereby, in the case where a member concerned with the transaction comes from a non-English-speaking country, the transaction cannot go through until the member translates and understands the details of the merchandise information.

Further, when each of the members concerned with the transaction translates the merchandise information individually, not only does it cost but also the members have to take the responsibility for mistakes in translation. Thereby, there have been problems that the members become apathetic to participating in e-commerce transactions, and that it is unclear who should pay the cost.

### SUMMARY OF THE INVENTION

It is therefore an object of the present invention to provide an e-commerce system, e-commerce method and control program thereof for managing the system and implementing the method by which it is possible to easily perform business transactions among a plurality of members who use a diversity of languages.

According to a first aspect of the present invention, for achieving the object mentioned above, there is provided an e-commerce system comprising:

a plurality of e-commerce market member terminals;

an e-commerce market control terminal; and

a communication line for connecting the e-commerce market member terminals and the e-commerce market control terminal, wherein:

the e-commerce market member terminal sends language information indicating a language that is to be used in a transaction to the e-commerce market control terminal, receives a commodity dictionary corresponding to the language information from the e-commerce market control terminal, and conducts business by using the commodity dictionary on the basis of operation by each of members who use a diversity of languages; and

the e-commerce market control terminal receives the language information from the e-commerce market member terminal, and sends the commodity dictionary corresponding to the language information to the e-commerce market member terminal on the basis of operation by an administrator.

According to a second aspect of the present invention, there is provided an e-commerce system comprising:

a plurality of e-commerce market member terminals;

an e-commerce market control terminal; and

a communication line for connecting the e-commerce market member terminals and the e-commerce market control terminal, wherein:

the e-commerce market member terminal sends member registration application information to the e-commerce market control terminal, sends language information indicating a language that is to be used in a transaction to the e-commerce market control terminal, receives and stores a commodity dictionary from the e-commerce market control terminal, and conducts business by applying the commodity dictionary on the basis of operation by each of members who use a diversity of languages; and

the e-commerce market control terminal receives the member registration application information from the e-commerce market member terminal, requests the e-commerce market member terminal to input the language information that is to be used in a transaction by the member in response to the member registration application information, receives the language information from the e-commerce market member terminal, stores the member registration application information and the language information that is to be used by the member in pairs, and sends the commodity dictionary corresponding to the language information specified by the member to the e-commerce market member terminal on the basis of operation by an administrator.

According to a third aspect of the present invention, in the e-commerce system described in the first or second aspect, the communication line is Internet.

According to a fourth aspect of the present invention, there is provided an e-commerce method wherein an e-commerce system comprises a plurality of e-commerce market member terminals and an e-commerce market control terminal, which are connected by a communication line, comprising:

a language information sending process wherein the e-commerce market member terminal sends language information indicating a language that is to be used in a transaction to the e-commerce market control terminal on the basis of operation by each of members who use a diversity of languages;

a language information receiving process wherein the e-commerce market control terminal receives the language information from the e-commerce market member terminal on the basis of operation by an administrator;

a commodity dictionary sending process wherein the e-commerce market control terminal sends a commodity dictionary corresponding to the language information to the e-commerce market member terminal on the basis of operation by an administrator;

a commodity dictionary receiving process wherein the e-commerce market member terminal receives the commodity dictionary corresponding to the language information from the e-commerce market control terminal; and

a business transaction process wherein the e-commerce market member terminal conducts business applying the commodity dictionary on the basis of operation by the member.

According to a fifth aspect of the present invention, there is provided an e-commerce method wherein an e-commerce system comprises a plurality of e-commerce market member terminals and an e-commerce market control terminal connected by a communication line, comprising:

a member registration application information sending process wherein the e-commerce market member terminal sends member registration application information to the e-commerce market control terminal on the basis of operation by each of members who use a diversity of languages;

a language information input request sending process wherein the e-commerce market control terminal receives the member registration application information from the e-commerce market member terminal, and requests the e-commerce market member terminal to input language information indicating a language that is to be used by the member in a transaction in response to the member registration application information on the basis of operation by an administrator;

a language information sending process wherein the e-commerce market member terminal receives the language information input request, and sends the language information to the e-commerce market control terminal on the basis of operation by the member;

a language information storing process wherein the e-commerce market control terminal stores the member registration application information and the language information that is to be used by the member in pairs on the basis of operation by an administrator;

a commodity dictionary sending process wherein the e-commerce market control terminal sends a commodity dictionary corresponding to the language information specified by the member to the e-commerce market member terminal on the basis of operation by an administrator;

a commodity dictionary receiving process wherein the e-commerce market member terminal receives and stores the commodity dictionary from the e-commerce market control terminal; and

a business transaction process wherein the e-commerce market member terminal conducts business applying the commodity dictionary on the basis of operation by the member.

According to a sixth aspect of the present invention, in the e-commerce method described in the fourth or fifth aspect, the communication line is Internet.

According to a seventh aspect of the present invention, there is provided a control program by which functions of the e-commerce system described in one of the aspects 1 to 3 is implemented.

According to an eighth aspect of the present invention, there is provided a control program by which the e-commerce method described in one of the aspects 4 to 6 is implemented.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a configuration of a conventional e-commerce system;

FIG. 2 is a diagram showing a configuration of an e-commerce system according to an embodiment of the present invention;

FIG. 3 is a flowchart explaining a process of taking possession of a commodity dictionary by a member;

FIG. 4 is a diagram showing an example in the case where member registration application information and language information are held in pairs in an e-commerce market control terminal 20;

FIG. 5 is a diagram showing an example of a commodity dictionary managed by the e-commerce market control terminal 20;

FIG. 6A is a diagram showing an example of a commodity dictionary that is to be sent from the e-commerce market control terminal 20 to an e-commerce market member terminal 10;

FIG. 6B is a diagram showing an example of a commodity dictionary that is to be sent from the e-commerce market control terminal 20 to an e-commerce market member terminal 10;

FIG. 6C is a diagram showing an example of a commodity dictionary that is to be sent from the e-commerce market control terminal 20 to an e-commerce market member terminal 10;

FIG. 7 is a flowchart explaining a process where merchandise information in the commodity dictionary is updated through the e-commerce market control terminal 20;

FIG. 8 is diagram showing an example where the commodity dictionary is updated at the e-commerce market control terminal 20;

FIG. 9A is a diagram showing an example where the commodity dictionary is updated at the e-commerce market member terminal 10;

FIG. 9B is a diagram showing an example where the commodity dictionary is updated at the e-commerce market member terminal 10;

FIG. 9C is a diagram showing an example where the commodity dictionary is updated at the e-commerce market member terminal 10;

FIG. 10 is a flowchart explaining a process of a business transaction wherein an order is given out and accepted concerned with commodities at the e-commerce market member terminal 10;

FIG. 11 is a diagram showing an example of an ordering screen by a company A;

FIG. 12 is a diagram showing an example of an ordering information reference screen displayed by a request from a company B.

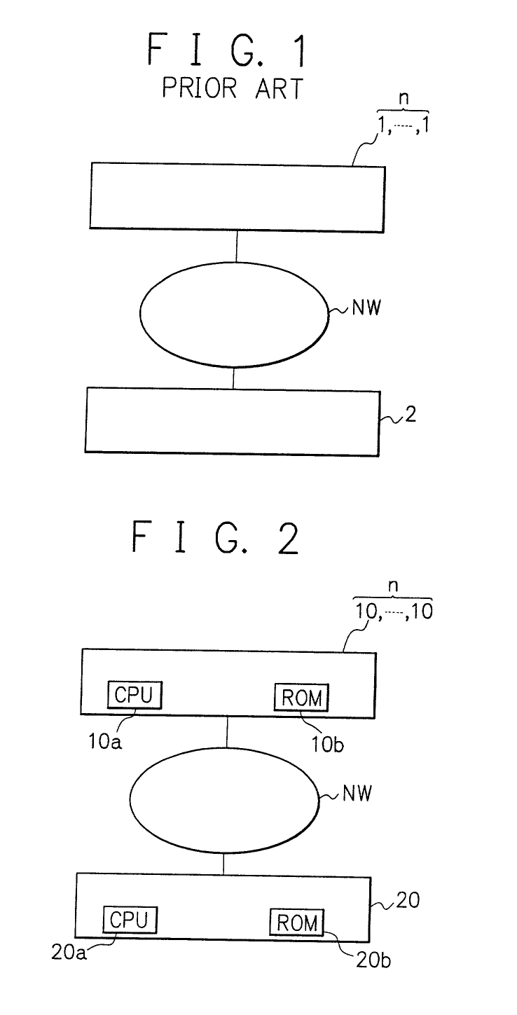

### DESCRIPTION OF THE PREFERRED EMBODIMENTS

Referring now to the drawings, an embodiment of the present invention is explained in detail.

FIG. 2 is a diagram showing a configuration of an e-commerce system according to an embodiment of the present invention.

As shown in FIG. 2, the e-commerce system in this embodiment comprises e-commerce market member terminals 10, . . . , 10 (which consist of n pieces thereop and e-commerce market control terminal 20, which are connected through a communication line (for example, the Internet) NW. The e-commerce market member terminal 10 may be, for example, information-processing equipment such as a personal computer put in a company and so forth, including a central processing unit (hereinafter referred to as “CPU”) 10a that controls all of the e-commerce market member terminals 10, . . . , 10 and a control program (for example, read only memory, hereinafter referred to as “ROM”) 10b that makes the CPU 10a operate.

On the basis of operation by each of the members who use a diversity of languages, the e-commerce market member terminal 10 transmits member registration application information to the e-commerce market control terminal 20 through the Internet NW. Further, the e-commerce market member terminal 10 transmits language information, which shows a language to be used by the member in conducting a business transaction, to the e-commerce market control terminal 20. In addition, the e-commerce market member terminal 10 receives and stores a commodity dictionary from the e-commerce market control terminal 20 through the Internet NW on the basis of operation by each member, and conducts a business transaction applying the commodity dictionary.

The e-commerce market control terminal 20 may be, for example, information-processing equipment such as a workstation server and so forth put in a merchandise information control company, including a CPU 20a that controls the whole of the e-commerce market control terminal 20 and a ROM 20b in which a control program that makes the CPU 20a operate is recorded. On the basis of operation by an administrator, the e-commerce market control terminal 20 receives the member registration application information from the e-commerce market member terminal 10 through the Internet NW. Then, the e-commerce market control terminal 20 sends a request that a member should input the language information to be used in conducting a transaction to the e-commerce market member terminal 10 through the Internet NW. In addition, the e-commerce market control terminal 20 receives the language information from the e-commerce market member terminal 10 through the Internet NW, stores the member registration application information and the language information in pairs, and sends the commodity dictionary corresponding to the language information specified by the member to the e-commerce market member terminal 10 through the Internet NW. The commodity dictionary includes uniquely distinct commodity codes independent of any language, and information such as commodity names that are differently written in a diversity of languages. The commodity dictionary written in a diversity of languages is stored in the e-commerce market control terminal 20, which is to be updated according to need.

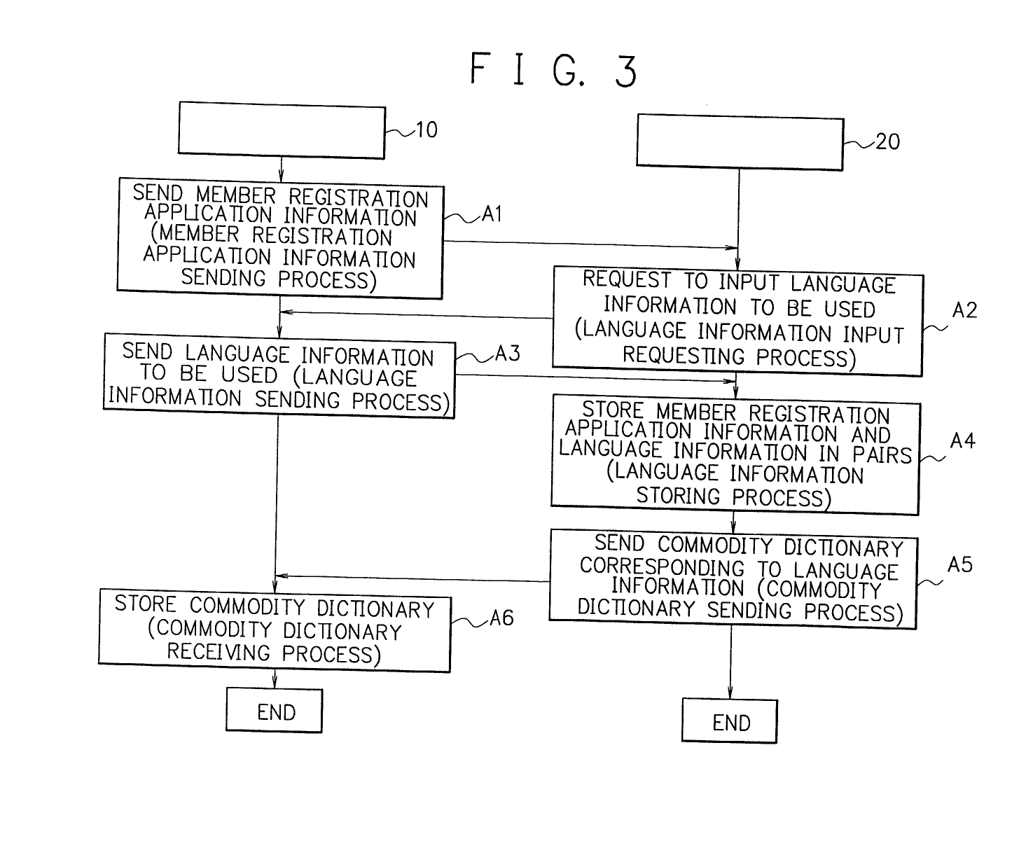

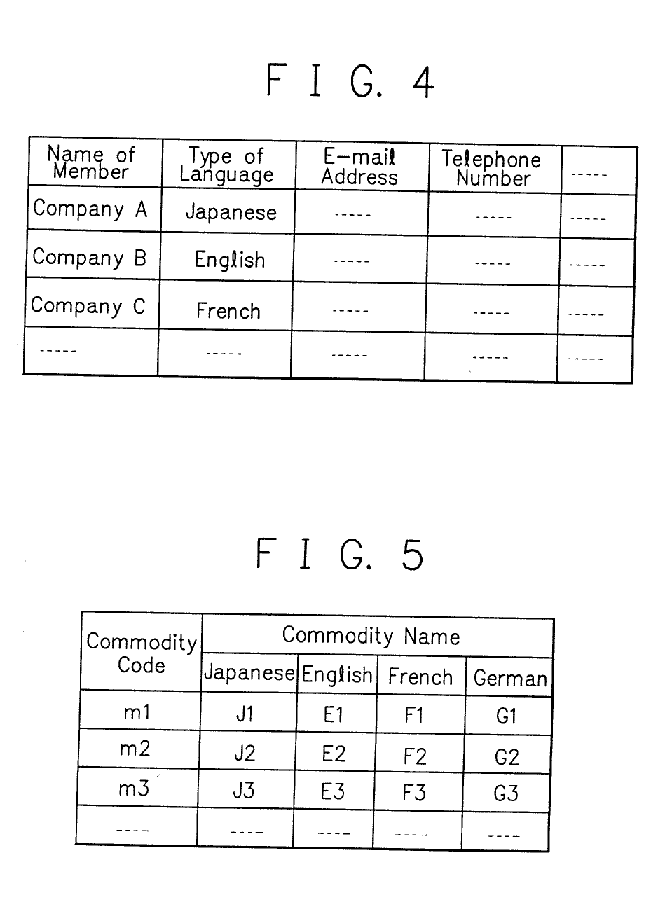

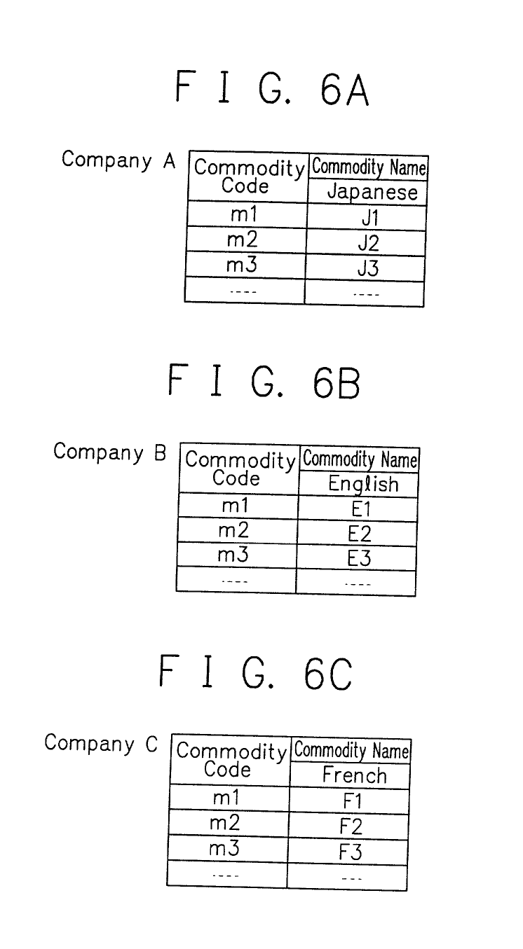

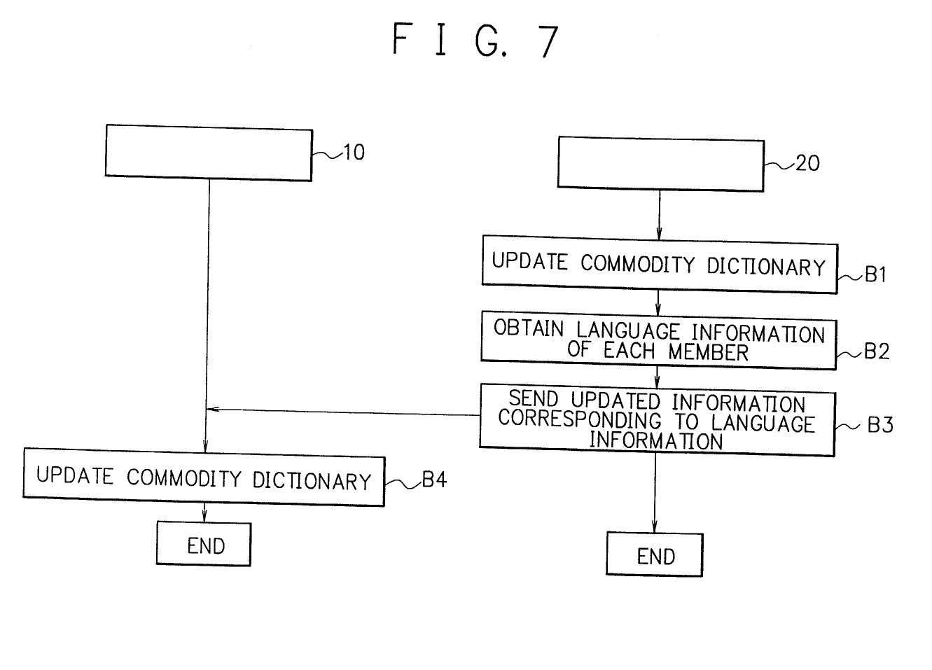

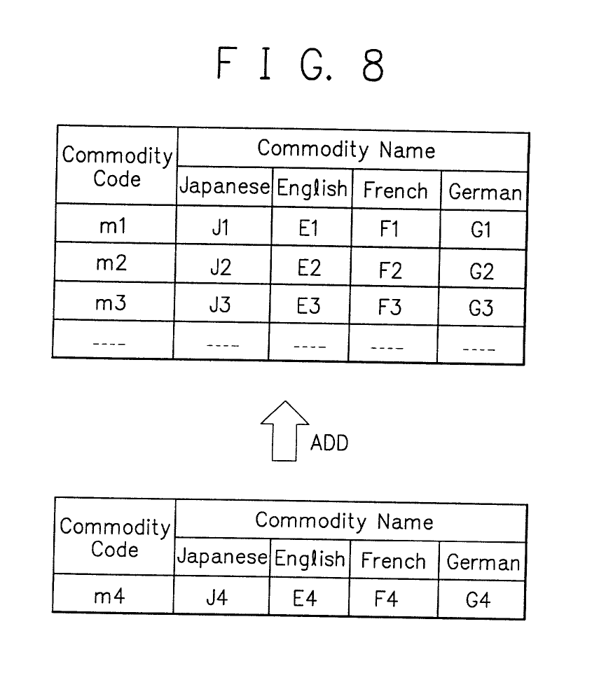

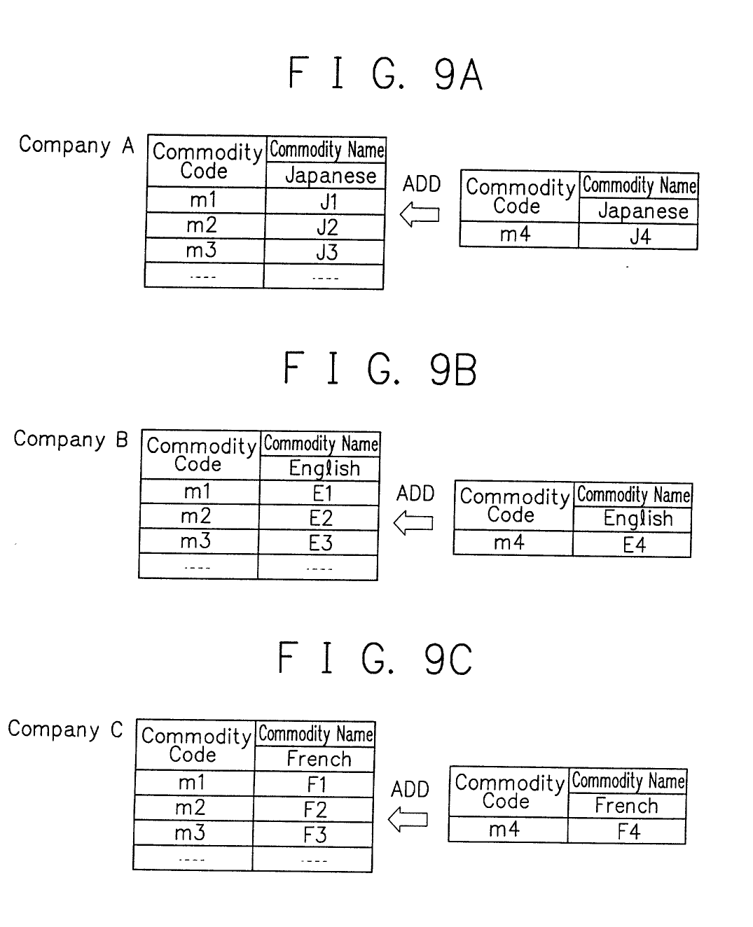

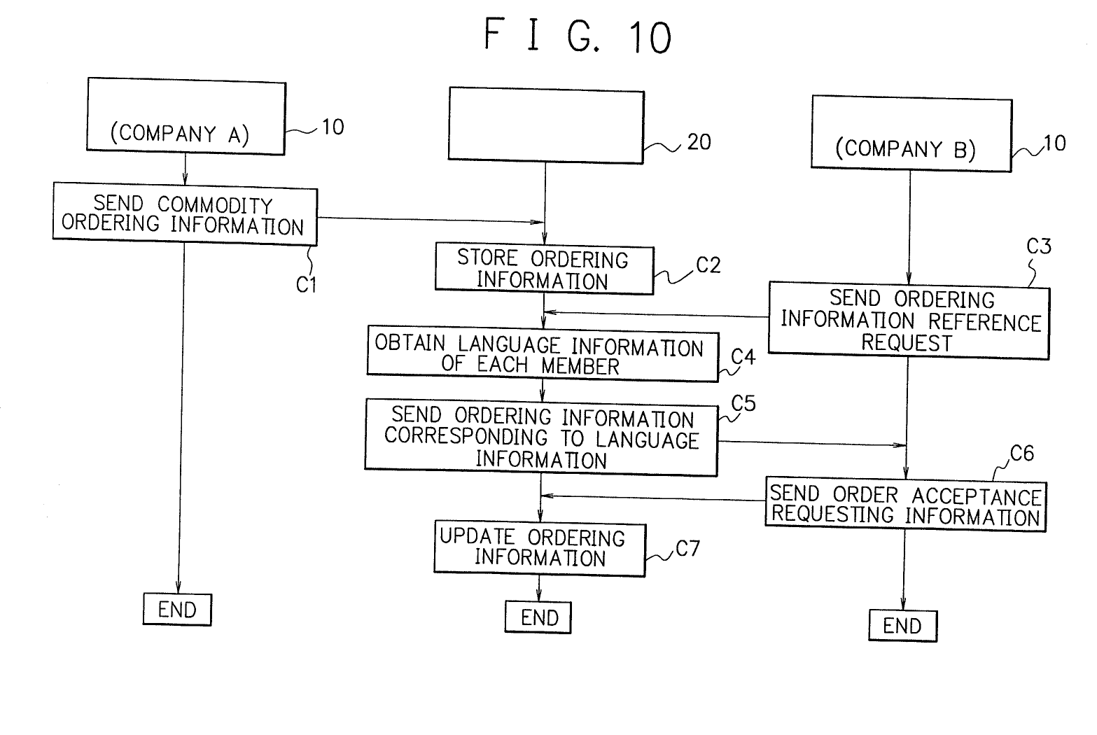

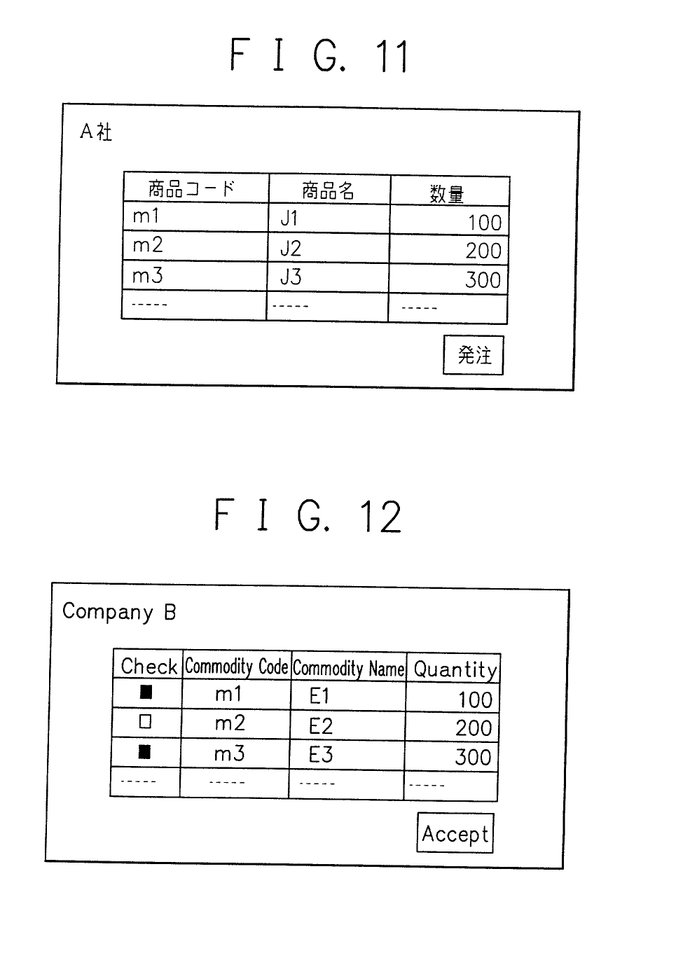

FIG. 3 is a flowchart explaining a process of taking possession of the commodity dictionary by a member. FIG. 4 is a diagram showing an example that the member registration application information and the language information are held in pairs in the e-commerce market control terminal 20. FIG. 5 is a diagram showing an example of the commodity dictionary in the control of the e-commerce market control terminal 20. FIGS. 6A to 6C are diagrams showing examples of the commodity dictionaries that are to be sent from the e-commerce market control terminal 20 to the e-commerce market member terminals 10, . . . , 10. FIG. 7 is a flowchart explaining a process where merchandise information in the commodity dictionary is updated through the e-commerce market control terminal 20. FIG. 8 is a diagram showing an example where the commodity dictionary is updated at the e-commerce market control terminal 20. FIGS. 9A to 9C are diagrams showing examples where the commodity dictionaries are updated at the e-commerce market member terminals 10, . . . , 10. FIG. 10 is a flowchart explaining a process of a business transaction wherein an order for commodities is given out and accepted applying the e-commerce market member terminal 10. FIG. 11 is a diagram showing an example of an order screen by a company A. FIG. 12 is a diagram showing an example of an order information reference screen displayed by a request from a company B.

In reference to these drawings, an explanation will be given about processes (1) to (3) of the e-commerce method in the e-commerce system according to the embodiment.

First, there will be given an explanation of process (1) in which a new member participates in the e-commerce market and takes possession of a commodity dictionary written in his/her everyday language.

As shown in FIG. 3, a new member sends member registration application information to the e-commerce market control terminal 20 through the Internet NW by operating the e-commerce market member terminal 10 in order to participate in the e-commerce market opened up by the e-commerce market control terminal 20 on the Internet NW (Step A1: member registration application information sending process). The e-commerce market control terminal 20 receives the member registration application information, and requests the e-commerce market member terminal 10 of the new member to input language information to be used in conducting a transaction through the Internet NW (Step A2: language information input requesting process).

By operating the e-commerce market member terminal 10, the new member sends the language information to be used in a transaction to the e-commerce market control terminal 20 through the Internet NW (Step A3: language information sending process). After that, the e-commerce market control terminal 20 stores the member registration application information and the language information to be used in a transaction in pairs (Step A4: language information storing process). In this case, as shown in FIG. 4, member registration information such as names of members (for example, company A, company B, company C, . . . ), e-mail addresses and telephone numbers, and language information to be used in transactions (for example, Japanese, English, French, . . . ) are kept in tabular form, for example.

The e-commerce market control terminal 20 maintains the commodity dictionary wherein a commodity (product) is described in a diversity of languages. In this commodity dictionary, as shown in FIG. 5, there are stored an English commodity name “E1”, a French commodity name “F1” and a German commodity name “G1” along with a Japanese commodity name “J1” with respect to a commodity having a commodity code “m1”. Then, on the basis of the description in the commodity dictionary, the e-commerce market control terminal 20 compiles a commodity dictionary corresponding to the language information specified by the new member, and sends the commodity dictionary compiled in the specified language to the e-commerce market member terminal 10 through the Internet NW (Step A5: commodity dictionary sending process).

In this case, as shown in FIG. 4, the “Company A” designates Japanese as the used language. Thereby, as shown in FIG. 6A, the e-commerce market control terminal 20 extracts the commodity codes and the Japanese commodity names thereof from the information shown in FIG. 5, compiles a commodity dictionary in Japanese for the company A, and sends it to the e-commerce market member terminal 10 of the company A through the Internet NW. In the same way, as shown in FIG. 6B, the e-commerce market control terminal 20 extracts the commodity codes and the English commodity names thereof from the information shown in FIG. 5, compiles a commodity dictionary in English for the company B, and sends it to the e-commerce market member terminal 10 of the company B through the Internet NW. Besides, as shown in FIG. 6C, the e-commerce market control terminal 20 extracts the commodity codes and the French commodity names thereof from the information shown in FIG. 5, compiles a commodity dictionary in French for the company C, and sends it to the e-commerce market member terminal 10 of the company C through the Internet NW. After that, as shown in FIG. 3, each e-commerce market member terminal 10 stores the compiled commodity dictionary sent from the e-commerce market control terminal (Step A6: commodity dictionary receiving process) so as to place an order with the e-commerce market by using the everyday language.

Next, there will be given an explanation of process (2) in which the contents of the commodity dictionary is updated by an administrator of the e-commerce market, and then, the renewal is reflected in the commodity dictionary stored by each member individually.

As shown in FIG. 7, an administrator of the e-commerce market updates the merchandise information in the commodity dictionary according to need by operating the e-commerce market control terminal 20 (Step B1). In this case, for example, as shown in FIG. 8, a new commodity having a commodity code “m4” is added in the e-commerce market. Then, the Japanese commodity name “J4”, the English commodity name “E4”, the French commodity name “F4”, and the German commodity name “G4” corresponding to the new commodity are registered in the commodity dictionary.

Each member in the e-commerce market needs only information corresponding to the specified language information to be used in conducting a transaction as effective information. Therefore, having retrieved the language information of each member (Step B2), the e-commerce market control terminal 20 sends only information corresponding to the language information to the e-commerce market member terminal 10 through the Internet NW (Step B3). The updated information sent from the e-commerce market control terminal 20 to the e-commerce market member terminal 10 is reflected in the commodity dictionary stored by each member by either automatic or manual means at the e-commerce market member terminal 10. Thereby, the commodity dictionary stored by each member is updated (Step B4). For example, as shown in FIG. 9A, the e-commerce market control terminal 20 notifies the “Company A” of the commodity code “m4” and the Japanese commodity name thereof “J4” only. In the same way, as shown in FIGS. 9B and 9C, the e-commerce market control terminal 20 notifies the “Company B” of the commodity code “m4” and the English commodity name thereof “E4” only, and the “Company C” of the commodity code “m4” and the French commodity name thereof “F4” only.

Lastly, there will be given an explanation of process (3) of conducting business when an order of commodities is given out and received by applying the e-commerce market member terminal 10.

As shown in FIG. 10, a member of the company A who hopes to place an order for commodities with the e-commerce market sends commodity ordering information to the e-commerce market control terminal 20 through the Internet NW by operating the e-commerce market member terminal 10 of the company A (Step C1). In this case, for example, an order screen shown in FIG. 11 is displayed on the e-commerce market member terminal 10 of the company A. This order screen is made up on the basis of the commodity dictionary stored in the e-commerce market member terminal 10 of the company A. As described above, the company A has designated Japanese as the language information on registering with members. Therefore, a Japanese commodity name corresponding to each of the commodity codes is recorded in the commodity dictionary stored in the e-commerce market member terminal 10 of the company A. Thereby, it is possible for the company A to give an order by using Japanese commodity names, which are in daily use. For example, when the member of the company A clicks the [symbol] (English equivalent for this Japanese is “order”) button on the order screen shown in FIG. 11, the ordering information is sent to the e-commerce market control terminal 20 through the Internet NW, and stored in the e-commerce market control terminal 20 (Step C2).

A member of the company B who hopes to receive an order from the e-commerce market sends an ordering information reference request to the e-commerce market control terminal 20 through the Internet NW by operating the e-commerce market member terminal 10 of the company B (Step C3). After receiving the ordering information reference request sent from the member of the company B, the e-commerce market control terminal 20 obtains the language information specified by the company B (Step C4). Then, the e-commerce market control terminal 20 converts (translates) the ordering information stored in Step C2 into the language specified by the company B, and sends the converted ordering information to the e-commerce market member terminal 10 of the company B through the Internet NW (Step C5).

As described above, the company B has designated English as the language information at the time of registering with members. Therefore, the e-commerce market control terminal 20 translates all the ordering information in Japanese sent from the company A into English expression. Then, as shown in FIG. 12, the ordering information reference screen in English is displayed on the e-commerce market member terminal 10 of the company B. Therefore, it is possible for the company B to choose a commodity(ies) for which the company B hopes to receive and accept the order by using English, which is in daily use. For example, when the member of the company B clicks the “Accept” button on the ordering information reference screen shown in FIG. 12, order acceptance requesting information about the commodities whose “check” columns are ticked off with “▪” is sent to the e-commerce market control terminal 20 through the Internet NW (Step C6). In the case where there is no competitor in trade, the acceptance of the order is confirmed. Then, the ordering information under the management of the e-commerce market control terminal 20 is updated (Step C7).

As described above, in this embodiment, language information that is to be used by members who conduct business is in the control of the e-commerce market control terminal 20. Moreover, commodity dictionaries corresponding to the language information are compiled. Further, the e-commerce market control terminal 20 executes all conversion (translation) processes of the languages concerned with information exchanged among the members who mutually use different languages. Thereby, the translation (conversion) process that was executed by each member individually is no longer required. Therefore, it becomes possible for the member to conduct business in security and at a lower cost with another member who uses another different language by using his/her own everyday language. Further, the e-commerce market control terminal 20 conducts all conversion processes of the languages concerned with a commodity dictionary, that is, the e-commerce market member terminal 10 does not need to execute the conversion process. Therefore, even the e-commerce market member terminal 10 that deals with only one language can perform business transactions with members around the world who use a diversity of languages. Especially, this embodiment has a marked effect on a cellular phone, a personal digital assistance and so forth that have become in widespread use rapidly and have been already shipped in large quantities, which are dealing with only a certain language.

The embodiment of the present invention has been described in detail with reference to drawings hereinbefore. It is to be appreciated that the concrete configuration of the embodiment can be changed or modified without departing from the scope and spirit of the present invention. For example, the terminals 10, . . . , 10 may be a cellular phone which can be connected to the Internet NW, and a specially manufactured terminal for digital information.

As set forth hereinabove, in this embodiment, language information that is to be used by members who conduct business is in the control of an e-commerce market control terminal. Moreover, commodity dictionaries corresponding to the language information are compiled. Further, the e-commerce market control terminal executes all conversion (translation) processes of the languages concerned with information exchanged among members who mutually use different languages. Thereby, the translation (conversion) process that was executed by each member individually is no longer required. Therefore, it becomes possible for the member to conduct business in security and at a lower cost with another member who uses another different language by using his/her own everyday language. Further, the e-commerce market control terminal conducts all conversion processes of the languages concerned with a commodity dictionary, that is, the e-commerce market member terminal does not need to execute the conversion process. Therefore, even the e-commerce market member terminal that deals with only one language can perform business transactions with members around the world who use a diversity of languages. Especially, this embodiment has a marked effect on a cellular phone, a personal digital assistance and so forth that have become in widespread use rapidly and have been already shipped in large quantities, which are dealing with only a certain language.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. An e-commerce system comprising:
a plurality of e-commerce market member terminals;
an e-commerce market control terminal; and
a communication line for connecting the e-commerce market member terminals and the e-commerce market control terminal, wherein:
the e-commerce market member terminal sends language information indicating a language that is to be used in a transaction to the e-commerce market control terminal, receives a commodity dictionary corresponding to the language information from the e-commerce market control terminal, and conducts business by using the commodity dictionary on the basis of operation by each of members who use a diversity of languages; and
the e-commerce market control terminal receives the language information from the e-commerce market member terminal, and sends the commodity dictionary corresponding to the language information to the e-commerce market member terminal on the basis of operation by an administrator.

2. An e-commerce system comprising:
a plurality of e-commerce market member terminals;
an e-commerce market control terminal; and
a communication line for connecting the e-commerce market member terminals and the e-commerce market control terminal, wherein:
the e-commerce market member terminal sends member registration application information to the e-commerce market control terminal, sends language information indicating a language that is to be used in a transaction to the e-commerce market control terminal, receives and stores a commodity dictionary from the e-commerce market control terminal, and conducts business by applying the commodity dictionary on the basis of operation by each of members who use a diversity of languages; and
the e-commerce market control terminal receives the member registration application information from the e-commerce market member terminal, requests the e-commerce market member terminal to input the language information that is to be used in a transaction by the member in response to the member registration application information, receives the language information from the e-commerce market member terminal, stores the member registration application information and the language information that is to be used by the member in pairs, and sends the commodity dictionary corresponding to the language information specified by the member to the e-commerce market member terminal on the basis of operation by an administrator.

3. The e-commerce system as claimed in claim 1, wherein the communication line is Internet.

4. The e-commerce system as claimed in claim 2, wherein the communication line is Internet.

5. An e-commerce method wherein an e-commerce system comprises a plurality of e-commerce market member terminals and an e-commerce market control terminal, which are connected by a communication line, comprising:
a language information sending process wherein the e-commerce market member terminal sends language information indicating a language that is to be used in a transaction to the e-commerce market control terminal on the basis of operation by each of members who use a diversity of languages;
a language information receiving process wherein the e-commerce market control terminal receives the language information from the e-commerce market member terminal on the basis of operation by an administrator;
a commodity dictionary sending process wherein the e-commerce market control terminal sends a commodity dictionary corresponding to the language information to the e-commerce market member terminal on the basis of operation by an administrator;
a commodity dictionary receiving process wherein the e-commerce market member terminal receives the commodity dictionary corresponding to the language information from the e-commerce market control terminal; and
a business transaction process wherein the e-commerce market member terminal conducts business applying the commodity dictionary on the basis of operation by the member.

6. An e-commerce method wherein an e-commerce system comprises a plurality of e-commerce market member terminals and an e-commerce market control terminal connected by a communication line, comprising:
a member registration application information sending process wherein the e-commerce market member terminal sends member registration application information to the e-commerce market control terminal on the basis of operation by each of members who use a diversity of languages;
a language information input request sending process wherein the e-commerce market control terminal receives the member registration application information from the e-commerce market member terminal, and requests the e-commerce market member terminal to input language information indicating a language that is to be used by the member in a transaction in response to the member registration application information on the basis of operation by an administrator;
a language information sending process wherein the e-commerce market member terminal receives the language information input request, and sends the language information to the e-commerce market control terminal on the basis of operation by the member;
a language information storing process wherein the e-commerce market control terminal stores the member registration application information and the language information that is to be used by the member in pairs on the basis of operation by an administrator;
a commodity dictionary sending process wherein the e-commerce market control terminal sends a commodity dictionary corresponding to the language information specified by the member to the e-commerce market member terminal on the basis of operation by an administrator;
a commodity dictionary receiving process wherein the e-commerce market member terminal receives and stores the commodity dictionary from the e-commerce market control terminal; and
a business transaction process wherein the e-commerce market member terminal conducts business applying the commodity dictionary on the basis of operation by the member.

7. The e-commerce method as claimed in claim 5, wherein the communication line is Internet.

8. The e-commerce method as claimed in claim 6, wherein the communication line is Internet.

9. A control program by which functions of the e-commerce system claimed in claim 1, 2, 3 or 4 is implemented.

10. A control program by which the e-commerce method claimed in claim 5, 6, 7 or 8 is implemented.
